(19) United States
(12) Patent Application Publication
(10) Pub. No.: US 2008/0288957 A1
(43) Pub. Date: Nov. 20, 2008

(54) METHOD AND SYSTEM FOR OPTIMIZING COMMUNICATION IN MPI PROGRAMS FOR AN EXECUTION ENVIRONMENT

(75) Inventors: Gheorghe Cascaval, Carmel, NY (US); Evelyn Duesterwald, Ossining, NY (US); Stephen E. Smith, Mahopac, NY (US); Peter F. Sweeney, Spring Valley, NY (US); Robert W. Wisniewski, Ossining, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/750,912

(22) Filed: May 18, 2007

(51) Int. Cl. G06F 13/00

(52) U.S. Cl. 719/313

(57) ABSTRACT

A system and method for mapping application tasks to processors in a computing environment that takes into account the hardware communication topology of a machine and an application communication pattern. The hardware communication topology (HCT) is defined according to hardware parameters affecting communication between two tasks, such as connectivity, bandwidth and latency; and, the application communication pattern (ACP) is defined to mean the number and size of bytes that are communicated between the different pairs of communicating tasks. By collecting information on the messages exchanged by the tasks that communicate, the communication pattern of the application may be determined. By combing the HCT and ACP a cost model for a given mapping can be determined. Any algorithm computing a mapping can use the HCT, ACP, and the cost model, thus the combination of an HCT, ACP, and cost model allow an automatically optimized mapping of tasks to processing elements to be achieved

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract. No. NBCH3039004 awarded by the Defense Advanced Research Projects Agency.

### BACKGROUND OF THE INVENTION

1. Field of the Invention

The present invention relates generally to reducing the communication cost between tasks running on different processing elements, which may be a processor, core, hardware thread, node, or computing machine in an execution environment.

2. Description of the Prior Art

Message Passing Interface (MPI) is the prevalent programming model for high performance computing (HPC), mainly due to its portability and support across HPC platforms. Because most HPC centers have a large variety of machines, portability is a major concern of MPI programmers. Therefore, MPI programs are typically optimized for algorithmic and generic communication issues.

There is a significant body of work on modeling communication between tasks in parallel programs; see for example, the reference to A. Aggarwal, et al. entitled “On communication latency in PRAM computation”, Proceedings of the ACM Symposium on Parallel Algorithms and Architectures, pages 11-21, June 1989; and, the reference to D. Culler, et al. entitled “Log P: Towards a realistic model parallel Computation”, Proceedings of the ACM SIGPLAN Symposium on Principles and Practices of Parallel Programming, May 1993. The entire contents and disclosure of these two references are incorporated by reference as if fully set forth herein.

Most of these models are designed in order to analyze parallel algorithms, and typically contain a small number of parameters that abstract the communication on the machine such that machine specific features are suppressed. Parallel computation models such as the Log P and Log GP, allow users to analyze parallel algorithms by providing a small set of parameters that characterize an abstract machine. Often times, the execution environment characteristics (actual machine specific characteristics) are ignored by design. For example, the Log P model intentionally leaves out the intercommunication network characteristics and the network routing algorithm in order to keep the model tractable.

In the reference to Traeff entitled “Implementing the MPI process topology mechanism”, Supercomputing '02: Proceedings of the 2002 ACM/IEEE conference on Supercomputing, pages 1-14, Los Alamitos, Calif., USA, 2002. IEEE Computer Society Press, there is presented a graph embedding algorithm that optimizes the MPI communication by matching the application communication patterns to the topology using the MPI virtual topology mechanism. His study focuses on the performance of the embedding algorithm and requires the user to specify the application communication patterns and to code the virtual topology in the application.

A. Pant and H. Jafri in their reference entitled “Communicating efficiently on cluster based grids with MPICH-VMI”, Cluster 2004, September 2004, presents two complementary approaches, which extend the MPICH implementation of MPI, to reduce the communication cost of an MPI application that runs on a cluster of machines. Their topology consists of slow wide-area links that interconnect clusters and faster links to interconnect processors within a cluster. They use a profile guided optimization approach to map MPI tasks to processors to reduce the cost of point to point communication. They also replace sets of communications with collective operations (e.g. allreduce or broadcast) to minimize the traffic on the slow inter-cluster links, using topology information.

It is understood that repeatability may be used to infer message sizes and change the MPI library to take advantage of the extra knowledge to reduce the amount of time spent on the rendezvous protocol.

In many cases, for a specific application running on a specific machine, the mapping of MPI tasks to processing elements has a significant impact on performance. This effect is due in part to the fact that many scientific applications exhibit a regular point-to-point communication pattern between a subset of the neighbors. Again this is partly a consequence of good MPI programming education—if global communication is needed, MPI programmers use collective operations over defined MPI communicators, which are typically tuned to the underlying architecture. However, MPI tasks are often mapped by default to the processing elements in a linear order, which may not be the mapping that achieves the best performance.

To address this problem, there is a need to be able to understand and model the hardware communication topology of the execution environment and the application communication pattern.

Thus, it would be highly desirable to provide an algorithm to map MPI tasks to processing elements, and a cost estimator, to evaluate a mapping algorithm's effectiveness in improving computing system performance.

### SUMMARY OF THE INVENTION

The present invention addresses the notion that the mapping of MPI tasks to processors has a significant impact on performance.

Accordingly, there is provided a system and method for mapping application tasks to processing elements in a computing environment that takes into account the communication topology of a machine and communication pattern of an application. The Hardware Communication Topology (HCT) is defined according to hardware parameters affecting communication between two tasks, such as connectivity, bandwidth, and latency. Bandwidth is derived for different message sizes. The HCT models processing elements and how the processing elements communicate as switch elements. The Application Communication Pattern (ACP) models point-to-point communication by capturing, from information collected on the messages exchanged by tasks that communicate, the number and size of messages that are communicated between the different pairs of communicating tasks of the application. Both the hardware communication topology and the application communication pattern can be advantageously used by an algorithm to determine a mapping of tasks to processing elements thereby benefiting overall performance.

Thus, given a hardware communication topology, and an application communication pattern, the invention provides a means for combining them to produce a mapping of tasks to processing elements. Moreover, a means is provided that, given the hardware communication topology and an application communication pattern, the cost of a particular mapping is calculated. Different mappings are explored and the most desirable one, as predicted by the cost algorithm, is chosen. The mechanism can be employed automatically and thus with it, it is feasible to optimize the execution environment on a machine-by-machine and application-by-application basis.

Thus, in accordance with one aspect of the invention, there is provided, in a computer system including multiple processors and a mechanism for the processing elements to communicate with each other, a hardware communication topology that models how processing elements communicate, and a program containing tasks that run on the processing elements and communicate, a method of providing a mapping of tasks to processing elements, the method comprising:

a) determining the hardware communication topology defined by the cost of communication between processing elements,

b) measuring the application communication pattern between said program tasks,

c) producing a mapping of said tasks to said processing elements by combining said determination with said measurement

Further, to this aspect of the invention, the hardware communication topology comprises: one or more processing elements, and one or more switch elements.

Moreover, the hardware communication topology may comprise a tree-structured topology having: one or more processing elements at a lowest level in the topology. Thus, the task mapping determination comprises: determining an amount of data communicated between tasks; and clustering said tasks for the switch elements at each level in said topology based on said data amount communicated. Clusters may be assigned at each level in said topology to the collections of processing elements at that level, in a manner that includes balancing of processing resources to improve communication balance.

The task mapping determination further implements concurrency to reduce communication imbalance by separating task clusters that exchange less data thereby allowing them to more evenly proceed in parallel.

Advantageously, the system and method of the invention for mapping application tasks to processing elements in a computing environment that takes into account the hardware communication topology of a machine and application communication pattern of an application results in significant performance advantages.

### BRIEF DESCRIPTION OF THE DRAWINGS

The objects, features and advantages of the present invention will become apparent to one skilled in the art, in view of the following detailed description taken in combination with the attached drawings, in which:

FIG. 1 illustrates a graph depicting the bandwidth (y-axis) for different message lengths (x-axis) when pairs of MPI tasks communicate concurrently;

FIGS. 2A and 2B respectively illustrate the two basic elements that are used to model a hardware communication topology: a processor element (FIG. 2A) and a switch element (FIG. 2B);

FIG. 3 depicts a model of an example hardware communications topology referenced herein for illustrating the inventive model and algorithm of the present invention;

FIG. 4 depicts schematically, a hardware communication topology 25 used for illustrating aspects of the present invention;

FIG. 5 is a flow chart depiction of an example heuristic algorithm 100 that maps MPI tasks to processing elements according to one aspect of the present invention; and,

FIG. 6 is an example pseudocode description of a cost estimator methodology for estimating the communication time (or cost) for a communication phase in accordance with the principles of the invention.

### DETAILED DESCRIPTION OF THE PREFERRED EMBODIMENTS

As referred to herein, the term “processing element” refers to an element adapted to provide a unit of computation.

A large class of scientific applications are written in a stylized manner. Typically these applications consist of a series of steps, where in each step, the application executes two phases: A computation phase in general is followed by a communication phase with synchronization between them. This class of applications has “concurrent communication” where the communication between MPI tasks occurs at the same time, i.e., there is a period of time during which all of the tasks are performing communication. In this class of applications, there are four places where performance can be improved: 1) Computation: the amount of time required to perform the computation; 2) Computation Imbalance: the difference between the longest and shortest compute times per phase; 3) Communication Overhead: the amount of time required to perform communication; and, 4) Communication Imbalance: the difference in time between when the last task finishes communication in a given phase from when the first task finishes.

The system and method of the present invention addresses reducing the communication overhead and imbalance in applications using MPI for communication. Improving computation performance is typically achieved with traditional performance analysis and tuning on a single processing element. This work reduces communication overhead and communication imbalance, and thereby improves performance, by adapting an application to its execution environment, without modifying source code. The system and method of the present invention focuses on how to exploit a hardware communication topology with respect to bandwidth and concurrency by explicitly mapping MPI tasks to processing elements to reduce the communication overhead of point-to-point communication. Bandwidth can be exploited to reduce communication overhead by mapping tasks that communicate the most data to areas of the topology that are closest together with the highest bandwidth. Concurrency can be exploited to reduce communication imbalance by separating tasks or groups of tasks that exchange less data thereby allowing them to more evenly proceed in parallel.

The problem of finding the best mapping for a given hardware communication topology and application communication pattern is exponential. Any MPI task may be mapped to any processing element. Thus, for “T” tasks there are T factorial mappings. Because there is an exponential number of mappings, any reasonable-sized problem requires a heuristic algorithm to determine a mapping.

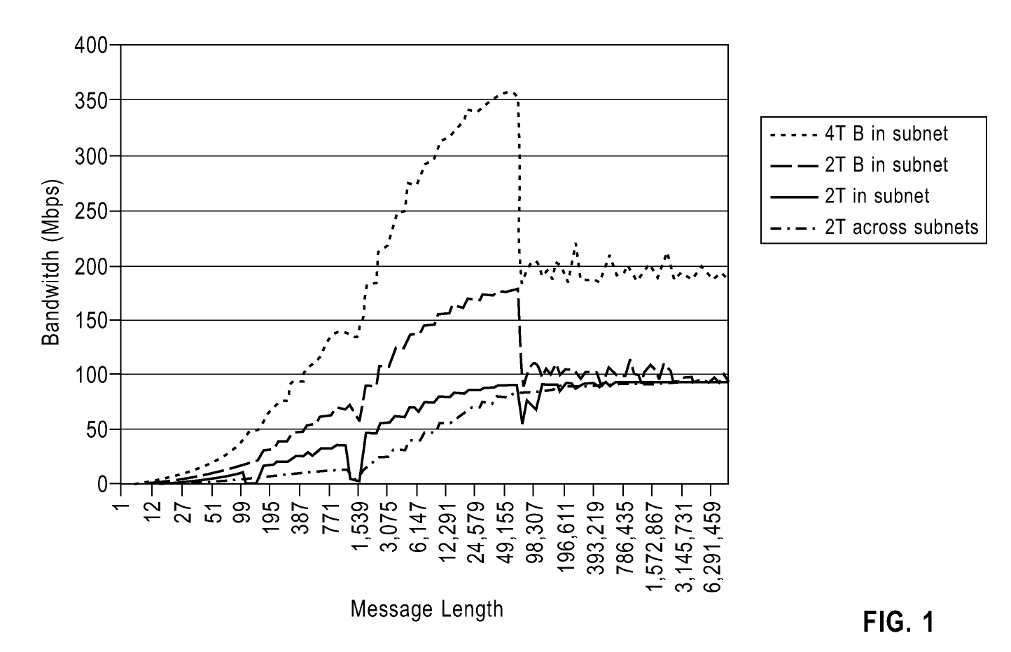

FIG. 1 illustrates a graph depicting the bandwidth (y-axis) for different message lengths (x-axis) when pairs of MPI tasks communicate concurrently. Using data obtained using the NetPIPE application (see, for example, http://www.scl.ameslab.gov/netpipe/), which is a network protocol independent evaluator, and mapping the tasks to different processing elements. The graph plots the following four communication configurations: the lowest line represents the unidirectional bandwidth when two tasks are mapped to processing elements on different machines in different subnets (labeled “2T across subnets”); the next higher line is the unidirectional bandwidth when two tasks are mapped to processing elements on different machines in the same subnet (labeled “2T in subnet”); next is the bidirectional bandwidth when two tasks are mapped to processing elements on different machines in the same subnet (labeled “2T B in subnet”); and the highest line represents when four tasks are mapped to processing elements on different machines in the same subnet (labeled “4T B in subnet”).

The graph in FIG. 1 illustrates that bandwidth varies with message length. For example, as message length increases up to 64 KB, bandwidth increases for all four configurations, then drops significantly as the MPI implementation switches message delivery mechanisms. Because bandwidth varies across message sizes, the inventive model for communication cost takes message length into consideration.

Further in the graph of FIG. 1, the top two lines, “2T B in subnet” and “4T B in subnet” show that when the number of communicating tasks doubles from two to four and each pair of communication tasks does not share processing or switch elements, the bidirectional bandwidth for a message length also doubles. The double of bandwidth is due to parallelism provided by the switch element, for example, when using an example network switch that has 8 switched 100 Mbps ports where each port may connect to additional switch elements or processing elements. It is a common characteristic of switches to have a higher internal bandwidth than on each of the ports. Because the internal bandwidth of a switch allows multiple concurrent ports to communicate, the inventive model for communication cost takes network parallelism into consideration.

Further it is evident from the graph of FIG. 1 that the mapping of tasks to processing elements impacts performance. For messages lengths of less than 64K bytes, the bandwidth is about half when two tasks are mapped to processing elements in different subnets (“2T across subnets”) then when they are mapped to processing elements in the same subnet (“2T in subnet”). Because the mapping of tasks to processing elements impacts performance, the inventive model for communication costs takes task mapping into consideration.

Finally, switch elements have a certain maximum bandwidth between any given pair of communicating tasks. That is, as shown from the graph of FIG. 1, multiple instances of communication throughput being bound by maximum bandwidth. As message lengths exceed 64 KB, the bandwidth is bound by 100 Mbps for all configurations other than “4T B in subnet”, which is bound by 200 Mbps. In the example graph depicted in FIG. 1, there is used a LAM MPI implementation (www.lam-mpi.org) that uses a hand-shaking protocol for messages whose length equal or exceed 64 KB. The hand-shake protocol is a bidirectional, rendezvous protocol that requires that the two tasks, prior to communication, ensure that the receiving task has a buffer available to receive the message. The handshake protocol effectively converts bidirectional communication to unidirectional. Because communication elements provide an upper limit for communicating tasks, an inventive model for communication cost takes into maximum bandwidth of the hardware communication topology resources.

The data from the graph depicted in FIG. 1, illustrates that the mapping of tasks to processing elements significantly affects the communication bandwidth and in turn the performance of the application. In particular, four characteristics have been abstracted that are crucial to modeling communication cost: 1) message length; 2) network parallelism; 3) mapping of tasks to processing elements; and 4) maximum bandwidth of a switch element.

While FIG. 1 and more data similar to it not presented herein illustrates that the behavior of the communication topology is complex, the present invention provides a simple model for achieving a tractable automatic mechanism for determining advantageous mappings.

The modeling of the hardware communication topology that MPI tasks use to communicate, and the modeling of application communication patterns from the data that these tasks communicate, are now described.

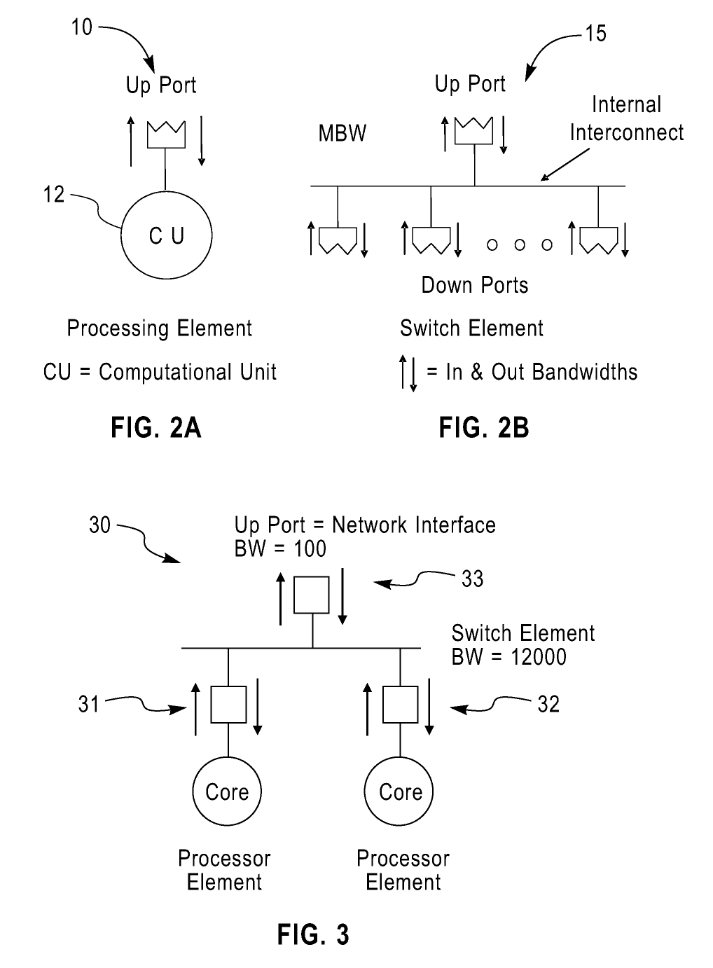

Today's large-scale machines are often constructed out of smaller SMP nodes connected in a hierarchical manner by a high bandwidth interconnect. The tree-structured hardware communication topology is modeled as shown in FIGS. 2A and 2B that respectively illustrate the two basic elements that are used to model a hardware communication topology: 1) a processing element 10, and, 2) a switch element 15. A processing element 10 represents a single computational unit at the lowest level in the hardware communication topology. For single threaded machines, a computational unit is a processor 12 (or core), for SMT machines it is the hardware thread. A switch element is used to combine lower-level components, either processing elements or switch elements. The hierarchical interconnect forms a tree-structured topology such as shown in FIG. 2B. It is understood however, that the topology may be configured as a mesh, a torus, or any generic graph structure having one or more processing elements at a lowest level in the topology. The switch element's “down ports” models the bandwidth to the lower-level components connected to the switch element. The single “up port” represents how a component communicates with a higher-level switch element. As shown in FIG. 2B, two bandwidths are associated with each port, an “in” bandwidth (pictorially represented as a down arrow) and an “out” bandwidth (pictorially represented as an up arrow). This represents the fact that bidirectional communication through a switch element port can occur in parallel. In addition, each pair of communicating tasks has the full bandwidth of the ports they are using provided no other tasks are using the same ports. If ports are shared between pairs of processing elements, then the port's aggregate bandwidth is bound by the maximal bandwidth of the port.

A hardware communication topology may define multiple processing elements to reflect multiple types of computation units and define multiple switch elements to reflect multiple types of switch elements. An exemplary, non-limiting hardware communication topology that will be referred to herein for illustrative purposes has two switch elements defined, one dual-processor machine, and another for a network 8-port 100 Mb switch.

FIG. 3 illustrates the modeling of the hardware communication topology for a dual-processor, single-threaded machine 30 that is used to illustrate the various aspects of the present invention. As shown in FIG. 3, each machine includes two single-threaded cores on a chip, the cores communicating with each other through memory; they do not share caches. The switch elements 31 and 32 model the memory bus to which the two cores are connected. The switch element 33 represents access to the network, with the indicated left up arrow modeling the up traffic from the computer to the network and the indicated down arrow modeling the communication from the network to the computer. The bandwidths (labeled “BW” in the figure) represents the maximum bandwidth for the in and out ports that were determined by running an example two NetPIPE processes on different processors in one machine. For example, the memory bandwidth is 12,000 Mbps.

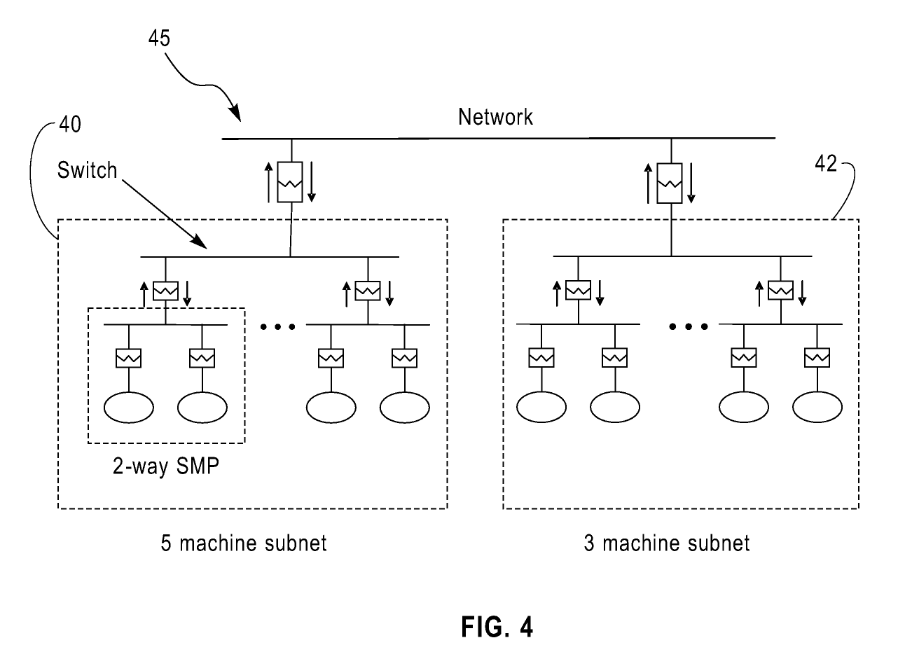

FIG. 4 depicts schematically, the hardware communication topology 45 used for illustrating aspects of the present invention. In the modeled hardware communication topology 45 of FIG. 4, there are eight (8) 2-way machines, five of the machines on one subnet 40, and three machines on another subnet 42. The switches on the subnet were 8-port 100 Mb switches and the subnets were connected together via a large crossbar switch with the same properties as the 8-port 100 Mb switch, i.e., 100 Mbps per port with higher internal connectivity. It is understood that other hardware topologies can be modeled in a similar tree-structured manner. For example, a machine (not shown) where each core has two hardware threads, each chip has two cores, and each module has four chips to provide 16 logical processing elements that communicate through the memory hierarchy may be modeled according to the principles of the invention.

An application communication pattern characterizes the way in which one MPI task exchanges data with another MPI task. An application communication pattern is characterized by the number of messages of each size that is communicated between each pair of MPI tasks. An application communication pattern does not contain the order that messages are sent between two MPI tasks.

Application communication patterns are derived from a trace of the point-to-point communication in an MPI application. A histogram of the communication is computed and is available to the analysis tools performing the MPI mapping task of the present invention. In particular classes of applications under consideration, only communication from a single phase needed to be modeled because each communication phase was representative of the other communication phases. This is true for many MPI applications. For those that have bimodal or other patterns between phases, each unique class of phases would need to be characterized with the weighted combination of those phases being used to determine the overall effect on performance. Thus, it is understood that application communication patterns may be specified in varying detail. Other possibilities include, on one hand, specifying that task A communicates with task B a total number of N bytes provides minimal detail. On the other hand, specifying the individual messages between two tasks with their size, latency and ordering provides additional detail that may be used to further characterize the application communication pattern if needed.

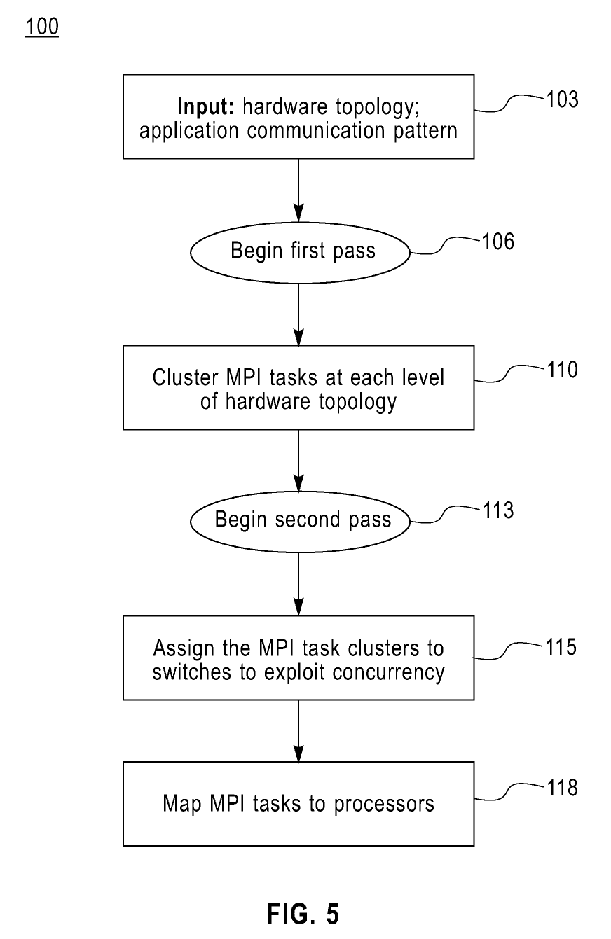

According to one embodiment of the invention, as depicted in the methodology depicted in FIG. 5, there is provided an example heuristic algorithm 100 that maps MPI tasks to processing elements. In this example approach, the heuristic algorithm maps MPI tasks to processing elements in a greedy manner. As shown at step 103, FIG. 5, the mapping algorithm takes as input a hardware communication topology, and the application communication pattern between MPI tasks. As shown in step 118 of FIG. 5, the mapping algorithm generates as output a mapping of MPI tasks to processing elements in the hardware communication topology. The algorithm assigns a single MPI task to a single processing element. It assumes a hierarchical topology where processing elements are on the lowest level of the hardware communication topology, and assumes that bandwidth stays the same or gets better as one moves lower (closer to the processing elements) in the hardware communication topology. The inventive algorithm optimizes performance by exploiting bandwidth differences on switch element ports in the hardware communication topology and by using concurrency in different subtrees of the topology.

Continuing in FIG. 5, the algorithm makes two passes over the topology. As indicated at step 106, for the first pass, starting from the bottom of the topology, the number of bytes communicated between the tasks is used to determine how to clusters tasks, as indicated at step 110. In this step, for example, tasks that communicate the greatest number of bytes are clustered together first. That is, as derived from software trace data used in tracking point-to-point communication paths for the given MPI application, the MPI tasks are grouped so that those tasks that communicate the most are placed physically close or between processing elements where the bandwidth is greatest. It is understood that the sufficient data for the heuristic may be collected during the modeling of a single MPI communication phase. From this, the processing elements of the topology are sorted to find which processing elements communicate the most data. Finally, at step 110, the algorithm clusters MPI tasks for the switch elements at each level in the topology without assigning MPI tasks to a particular switch element.

Thus, in accordance with the bottom-up pass, as depicted in FIG. 5, the algorithm starts by creating clusters where each cluster includes a single MPI task and, setting the next to the lowest level in the topology to the current level in the HCT. Initially the number of clusters is the number of MPI tasks. The algorithm computes the communication cost between all subsets of clusters in the current level where communication cost is the number of bytes that would need to be communicated between all the MPI tasks contained in one cluster of the subset with all the MPI tasks in the other clusters of the subset and the subset size is determined by the number of processing elements reached by a switch element at current level in the HCT. After communication costs are computed, they are sorted. When sorted in descending byte order, the algorithm creates new clusters for the next level in the topology by combining subsets of clusters in the current level whose elements have not already been paired. After all the clusters in the current level are assigned to a cluster in the next level, the algorithm iterates by setting the current level to the next level.

Then, the process continues as shown at step 113, where the second pass of the heuristic starts from the top to assign the clusters (MPI task groups) to switch elements to exploit concurrency as indicated at step 115. That is, in accordance with the top-down pass, as depicted in FIG. 5, the algorithm starts at the top level in the topology and assigns clusters at that level to the switch elements at that level before going down a level. For example, if it is determined that two cluster groups communicate on the same machine, resources on that machine will be tied up. Thus, to exploit concurrency, these particular clusters will be assigned to different (separate) machines. For example, given four (4) clusters, two (2) that communicate with 10 MB of data, and two (2) that communicate with 100 MB of data, and at this level in the HCT a switch element can be assigned at most two clusters, concurrency will balance the resources such that one (1) task of 10 MB and one (1) task of 100 MB may be assigned to one switch element, and, the other task of 10 MB and the other task of 100 MB may be assigned to a second separate switch element. Utilizing concurrency in this manner, eliminates communication imbalance by not placing the two heavily communicating clusters on the same switch.

The complexity of the algorithm described herein with respect to FIG. 5, is bounded by a sort operation on the number of communication pairs of MPI tasks. The bound is O(R log R), where R is the pairs of MPI tasks that communicate which in turn is bounded by T * T where T is the number of MPI tasks. In reality, R is much lower than T because all tasks do not communicate with all other tasks.

In the example embodiment described herein with respect to FIG. 5, the heuristic algorithm does not employ the cost estimator, but only at the end to determine if the result is expected to outperform a default mapping. It is understood that another class of heuristic algorithms could use the cost estimator during the algorithm. This may be done either directly or in a probabilistic manner to help avoiding local minima. It is understood that other heuristic algorithms may be employed that generate better performing MPI task to processing element mappings.

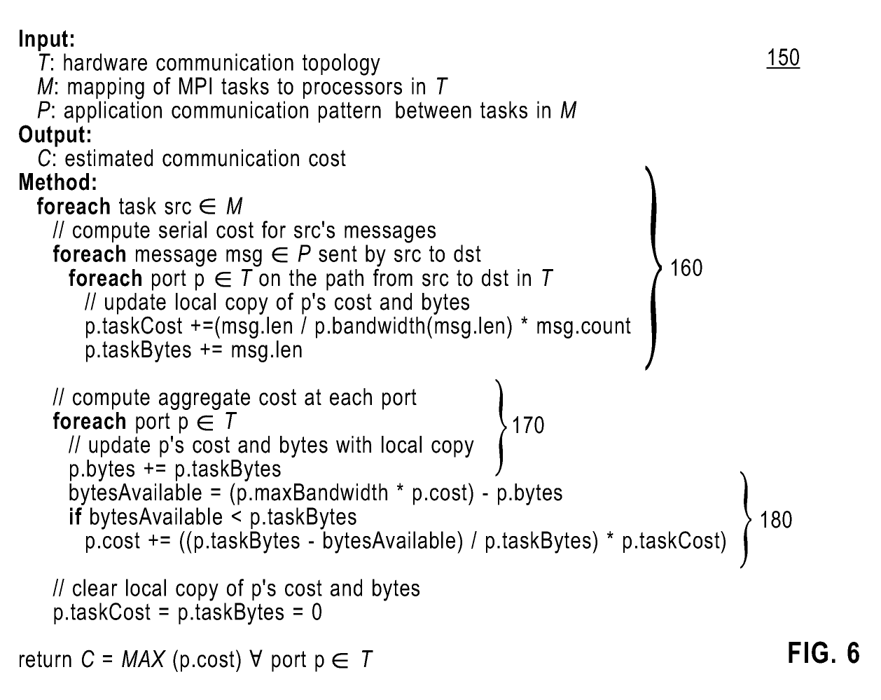

Given the hardware communication topology “T”, the mapping of MPI tasks to processing elements “M”, and the application communication pattern between these tasks “P”, the cost estimator estimates the communication time (or cost “C”) for a communication phase using the algorithm as now described herein with respect to FIG. 6.

For illustrative purposes, the model depicted in FIG. 6 is simple yet accurate enough to be used in predicting which mapping would perform better. For application communication patterns, only the number and the size of the messages, respectively, the “count” and “len” variables in the code depicted in FIG. 6, between two tasks is maintained. The order in which messages are sent is not taken into consideration. For the hardware communication topology, the observed bandwidth per message length, network parallelism, and the maximum bandwidth of a port are parameters in the model. The values used for these parameters may be obtained using the aforementioned NetPIPE (see, for example, Q. Snell, A. Mikler, and J. Gustafson reference entitled “Netpipe: A network protocol independent performance evaluator,” 1996) running between different combinations of tasks mapped to processing elements, as explained hereinabove. Further, for illustrative purposes, the inventive algorithm assumes concurrent communication. That is, an application is comprised of computation and communication phases and it is during a communication phase that the MPI tasks exchange data.

Referring now to FIG. 6, according to the cost estimator algorithm 150, for each task, the cost estimator implements two steps: 1) a first step 160 for serialization computes, for each message, the cost “p.taskCost” and bytes “p.taskBytes” at each switch element port in the hardware communication topology through which the message flows. Because the messages are processed serially and the cost and bytes at each port are accumulated, the maximum bandwidth at any port is guaranteed not to be exceeded for the current task's communication; and 2) a second step 170 and 180 for aggregating the current task's bytes “taskBytes” and cost “taskCost” respectively at each port, “p”, limiting the aggregation by p's maximum bandwidth. This step models network contention, when communicating tasks share switch elements resources. The indicated variable “p.bytesAvailable” is the number of additional bytes that can be communicated at “p” without exceeding p's maximum bandwidth. As shown in FIG. 6, logic 180 is implemented such that if “p.bytesAvailable” is less than the number of bytes sent by the messages of the current task at p (p.taskBytes), additional cost has to be added to “p.cost”. The estimator computes the additional cost as a fraction of the task's cost “taskCost”, where the fraction is computed as (p.taskBytes-bytesAvailable)/p.taskBytes).

After all communication of all tasks is processed, the total time “C” for the communication phase is taken as the maximum time over all ports in the hardware communication topology.

The complexity of this algorithm is O(M×N) where M is the number of messages sent between MPI ranks and N is the number of ports in the hardware communication topology.

As the cost estimator assumes fully concurrent communication, the cost estimator may be less accurate for those applications where only a percentage of their communication is concurrent. It is understood that the approach of the model described herein, while sufficiently accurate enough to model the applications as presented herein, may be extended by taking into account the percentage overlap, i.e., addressing the tradeoff between the improved accuracy and increased model complexity.

As is readily seen from FIGS. 5 and 6, a small set of parameters are defined that characterize both the hardware communication topology (HCT) and the application communication pattern (ACP). The cost estimator provided herein takes as input a HCT, an ACP and a mapping of tasks to processing elements, and estimates the communication cost of the mappings. As mentioned, this cost estimator can be embedded in heuristic algorithms to guide their choices or can be used once a heuristic algorithm produces a mapping to determine which mapping is more advantageous.

The inventive methodology that provides a mapping of MPI tasks to processing elements in an MPI program is a critical decision that significantly impacts performance. By taking into account both the characteristics of the hardware communication topology (memory and network) and of the application communication pattern, the methodology described herein estimates a communication cost. Using the HCT, ACP, and cost estimator, a heuristic algorithm may be used to generate a mapping of MPI tasks to processing elements that improves overall performance for the given execution environment. The invention is not limited to implementing a heuristic task to map MPI tasks to processing elements and then computing the cost estimate based on that mapping. Other MPI mappings may be used that may be evaluated using the cost estimator to determine a spread of performance between a best-case and a worst-case mapping. For example, it would be possible at each level to probabilistically cluster processing elements with the likelihood assigned in a weighted manner based on the amount they communicate, but then run the cost estimator after each clustering level to determine if a particular cluster is more or less beneficial. Tying in the cost estimator to the heuristic algorithm allows for the information contained therein, i.e., the cost estimator, to guide the heuristic, however at a cost because the cost estimator itself must be more frequently run. Other simplistic heuristic algorithms for example generating a random mapping and using the cost estimator to evaluate each mapping are all possibilities as provided by the current invention.

The invention has been described herein with reference to particular exemplary embodiments. Certain alterations and modifications may be apparent to those skilled in the art, without departing from the scope of the invention. For instance, the task mapping algorithm may employ the communication cost metric as it running to determine if the result is expected to outperform the default mapping. The exemplary embodiments are meant to be illustrative, not limiting of the scope of the invention.

Having thus described our invention, what we claim as new, and desire to secure by Letters Patent is:

1. In a computer system containing multiple processing elements and a mechanism for enabling the processing elements to communicate with each other, and a program executing tasks that run on the processing elements and communicate, a method of providing a mapping of tasks to said processing elements, said method comprising:
a) determining the cost of communicating between processing elements,
b) measuring the application communication pattern between said program tasks,
c) producing a mapping of said tasks to said processing elements by combining said determination with said measurement.

2. The method as recited in claim 1, wherein the mechanism for enabling the processing elements to communicate with each other includes one or more of: switch elements, registers, any memory level in a cache memory storage hierarchy, a memory, a shared bus, one or more interconnect connects, one or more external switches, or combinations thereof.

3. The method as recited in claim 1, where the application communication pattern captures any characteristic of message including one or more of: size, histogram of message size, order of messages, order and size of messages.

4. The method as recited in claim 2, wherein the mechanism for the processing elements to communicate with each other is configured as one of: a tree-structured topology, a mesh, a torus, or any generic graph structure, having: one or more processing elements at a lowest level in the topology.

5. The method as recited in claim 4, wherein said task mapping comprises:
determining an amount of data communicated between tasks; and,
clustering said tasks for switch elements at each level in said topology based on said data amount communicated.

6. The method as recited in claim 5, wherein said task mapping further comprises:
assigning the clusters at each level in said topology to the switch elements at that level, said assigning including balancing of processing resources.

7. The method as recited in claim 5, wherein said task mapping further implements concurrency to reduce communication imbalance by separating task clusters that exchange less data to thereby allow the task clusters to more evenly proceed in parallel.

8. The method as recited in claim 1, where the task mapping comprises one of: a heuristic algorithm, a random algorithm, or an exhaustive algorithm that explores a whole parameter space that characterize both said hardware communication topology and said application communication pattern.

9. The method as recited in claim 2, wherein said cost determining implements a cost estimator to determine the communication cost of a task mapping, said cost estimator comprising:
for each task:
aggregating for each message, a cost and bytes at each switch element through which the message flows; and,
aggregating the current task's cost and bytes at each switch element; and,
limiting the aggregation of said current task's cost and bytes to not exceed a maximum bandwidth associated with said switch element.

10. The method as recited in claim 1, for use in determining which mapping reduces communication costs.

11. The method as recited in claim 1, wherein said tasks are MPI tasks that exchange data during a communication phase.

12. In a computer system containing multiple processing elements and a mechanism for enabling the processing elements to communicate with each other, and a program executing tasks that run on the processing elements and communicate, a system for providing a mapping of tasks to said processing elements comprising:
means for determining the cost of communicating between processing elements,
means for measuring the application communication pattern between said program tasks; and,
means for producing a mapping of said tasks to said processing elements by combining said determination with said measurement.

13. The system as recited in claim 12, wherein the mechanism for enabling the processing elements to communicate with each other includes one or more of: switch elements, registers, any memory level in a cache memory storage hierarchy, a memory, a shared bus, one or more interconnect connects, one or more external switches, or combinations thereof.

14. The system as recited in claim 12, wherein the means for measuring the application communication pattern captures any characteristic of message including one or more of: size, histogram of message size, order of message, order and size of messages.

15. The system as recited in claim 1, wherein the mechanism for the processing elements to communicate with each other is configured as one of: a tree-structured topology, a mesh, a torus, or any generic graph structure, having: one or more processing elements at a lowest level in the topology.

16. The system as recited in claim 12, wherein said task mapping means comprises:
means for determining an amount of data communicated between tasks; and,
means for clustering said tasks for switch elements at each level in said topology based on said data amount communicated.

17. The system as recited in claim 16, wherein said task mapping means further comprises:
means for assigning the clusters at each level in said topology to the switch elements at that level, said means for assigning further balancing processing resources.

18. The system as recited in claim 16, wherein said task mapping means further implements concurrency to reduce communication imbalance by separating task clusters that exchange less data to thereby allow said task clusters to more evenly proceed in parallel.

19. The system as recited in claim 12, where the task mapping means comprises one of: means for executing a heuristic algorithm, a random algorithm, or an exhaustive algorithm that explores a whole parameter space that characterize both said hardware communication topology and said application communication pattern.

20. The system as recited in claim 13, wherein said cost determining means implements a cost estimator to determine the communication cost of a task mapping, said cost estimator comprising:
for each task:
aggregating for each message, a cost and bytes at each switch element through which the message flows; and,
aggregating the current task's cost and bytes at each switch element; and,
limiting the aggregation of said current task's cost and bytes to not exceed a maximum bandwidth associated with said switch element.

21. The system as recited in claim 12, for use in determining which mapping reduces communication costs.

22. The system as recited in claim 12, wherein said tasks are MPI tasks that exchange data during a communication phase.

23. A program storage device readable by a machine, tangibly embodying a program of instructions executable by the machine to perform method steps for providing a mapping of tasks to processing elements in a computer system including multiple processing elements and a mechanism for enabling the processing elements to communicate with each other, and a program executing tasks that run on the processing elements and communicate, said method steps comprising:
a) determining the cost of communicating between processing elements,
b) measuring the application communication pattern between said program tasks,
c) producing a mapping of said tasks to said processing elements by combining said determination with said measurement.
